(19) United States
(12) Patent Application Publication
(10) Pub. No.: US 2011/0040218 A1
(43) Pub. Date: Feb. 17, 2011

(54) REMOVABLE MASSAGE ASSEMBLY

(75) Inventor: Roman S. Ferber, West Bloomfield, MI (US)

Correspondence Address: BROOKS KUSHMAN P.C., 1000 TOWN CENTER, TWENTY-SECOND FLOOR, SOUTHFIELD, MI, 48075, US

(73) Assignee: FKA DISTRIBUTING CO. D/B/A HOMEDICS, INC., Commerce Township, MI (US)

(21) Appl. No.: 12/990,017

(22) PCT Filed: Apr. 30, 2009
(86) PCT No.: PCT/US2009/042295

§ 371 Date: Oct. 28, 2010

Related U.S. Application Data
(60) Provisional application No. 61/049,526, filed on May 1, 2008.

(51) Int. Cl. A61H 1/00

(52) U.S. Cl. 601/49

(57) ABSTRACT

A massager is provided with a body support member having a frame with a cavity. A substrate has a series of receptacles and is mounted to the frame. A plurality of removable vibratory massage units are each mounted within one of the receptacles for imparting a vibratory massage effect. A massage chair is provided with a base for resting upon an underlying support surface. A seat bottom is supported upon the base. A seat back is supported by the base and/or the seat bottom. The massager is provided in the seat back and/or the seat bottom. A method for permitting selective removal of a massage assembly from a massager provides a body support member with a frame and a cavity, and a substrate with a series of receptacles. The substrate is installed to the frame. A plurality of removable vibratory massage units are installed in the receptacles.

### CROSS-REFERENCE TO RELATED APPLICATIONS

This application claims the benefit of U.S. provisional application Ser. No. 61/049,526 filed May 1, 2008, the disclosure of which is incorporated by reference herein.

### BACKGROUND

1. Technical Field

Various embodiments of the invention relate to massagers and massage chairs.

2. Background Art

The prior art has provided various massagers and massager chairs with various massage features. Vibratory massagers and massager chairs often include multiple vibratory massage units. Varying massages are provided by programming which varies a pattern or intensity of various massage units.

### SUMMARY

One embodiment provides a massager with a body support member having a frame with a cavity. A substrate is mounted to the frame. The substrate has a series of receptacles. A plurality of removable vibratory massage units are each mounted within one of the receptacles for imparting a vibratory massage effect to the body support member.

Another embodiment provides a massage chair with a base for resting upon an underlying support surface. A seat bottom is supported upon the base. The seat bottom has a frame with a cavity. A seat back is supported by the base and/or the seat bottom. A removable massage assembly is installed to the seat bottom frame.

Another embodiment provides method for permitting selective removal of a massage assembly from a massager. A body support member is provided with a frame and a cavity. A substrate is provided with a series of receptacles. The substrate is installed to the frame. A plurality of removable vibratory massage units are provided. The plurality of massage units are installed in the receptacles.

### BRIEF DESCRIPTION OF THE DRAWINGS

FIG. 1 is a rear perspective view of a chair with a removable massage assembly according to an embodiment of the present invention;

FIG. 2 is a rear perspective view of another chair with a removable massage assembly according to another embodiment; and

FIG. 3 is a front perspective view of a chair with a removable massage assembly according to yet another embodiment.

### DETAILED DESCRIPTION OF EMBODIMENTS

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

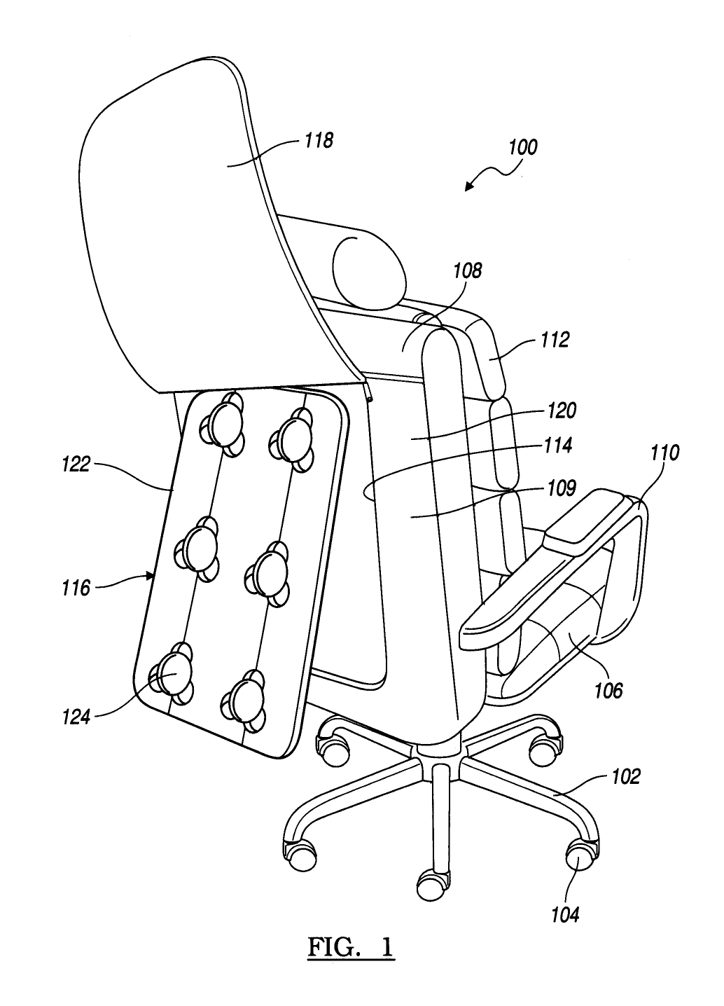

With reference now to FIG. 1, a massage apparatus is illustrated in accordance with an embodiment of the present invention and is depicted as a chair and referenced generally by numeral 100. In at least one embodiment, the chair 100 is an office chair having a base 102 with casters 104 for supporting the chair 100 upon an underlying support surface, and for transporting the chair 100 along the underlying support surface. The chair 100 has a seat bottom 106 that is mounted to the base 102 for seating and supporting a user. The seat bottom 106 may include a frame that is covered with cushioning, such as foam padding, and a cover. A seat back 108 is mounted to the seat bottom 106 for receiving a back of the user and for supporting the back of the user. Similar to the seat bottom 106, the seat back 108 includes a frame 109 that is covered by cushioning, which may be foam padding, and a cover.

The chair 100 may also include a pair of armrests 110 that are each mounted to the seat bottom 106 and extend upward from lateral sides of the seat bottom 106 to the seat back 108 for receiving and supporting the arms of the user.

As is known in the art, each of the structural features of the chair 100 may be adjustable. For example, the height of the seat bottom 106 may be adjustable relative to the base 102; a resistance spring force upon a tilt connection between the seat bottom 106 and the base 102 may be adjustable; a tilt angle of the seat back 108 relative to the seat bottom 106 may be adjustable; and the seat bottom 106 may be pivotally connected to the base 102 for adjustment of angular orientation of the seat bottom 106 and seat back 108 relative to the base 102.

The seat back 108 includes the frame 109 that is padded with cushioning and a cover 112. The cover 112 and underlying cushioning extend across the seat back frame 109, which is depicted including a lower pelvic region, an upper shoulder region, and a headrest region. The seat back 108 includes a cavity 114 within the seat back frame 109. In the embodiment depicted, the seat back frame 109 is a peripheral frame such that the cavity 114 is located centrally.

The cavity 114 provides a location for storage of a massage assembly 116. An access panel is provided by a flap 118 in a cover 120 of the rear of the seat back 108 for providing access to the massage assembly 116 in the opened position in FIG. 1, and for concealing the massage assembly 116 in a closed position. The flap 118 may be closed by utilization of a lengthwise fastener, such as a zipper.

The massage assembly 116 depicted in FIG. 1 is a vibratory massage assembly having a substrate 122 for attachment to the frame of the seat back 108 within the cavity 114. A plurality of motor-driven vibratory massage units 124 are each mounted to the substrate 122. The massage units 124 collectively provide a vibratory massage effect across the massage assembly 116 that is imparted to a user seated against the forward cover 112 of the seat back 108.

The substrate 122 is secured within the frame 109 of the seat back 108 by any conventional mechanical securement device, such as fasteners or clamps. The massage assembly 116 may include a wire harness that plugs into a wire harness of the seat back 108 for controlling and powering the massage assembly 116.

Additionally, the substrate 122 is selectively attachable to the frame 109 of the seat back 108 for replacement. For example, if a motor of one of the massage units 124 fails, the user can remove the massage assembly 116 and replace it with another massage assembly 116. Alternatively, the user can repair the massage assembly 116 or send the massage assembly 116 to a repair site, such as a repair or replacement facility designated by the manufacturer. As another alternative, the user can remove the faulty massage unit 124 and replace it with another massage unit 124 and then reinstall the massage assembly 116. Alternatively, the replaceable massage assembly 116 can be interchanged with another massage assembly with a varying arrangement of massage units 124. Other known suitable massage assemblies or units can be utilized in combination with the seat back 108 such as rotary kneading massage units, roller massage units, percussion (tapping) massage units, and any other suitable massage unit that can be contained within the seat back 108. As yet another alternative, the user can remove the massage assembly 116 altogether.

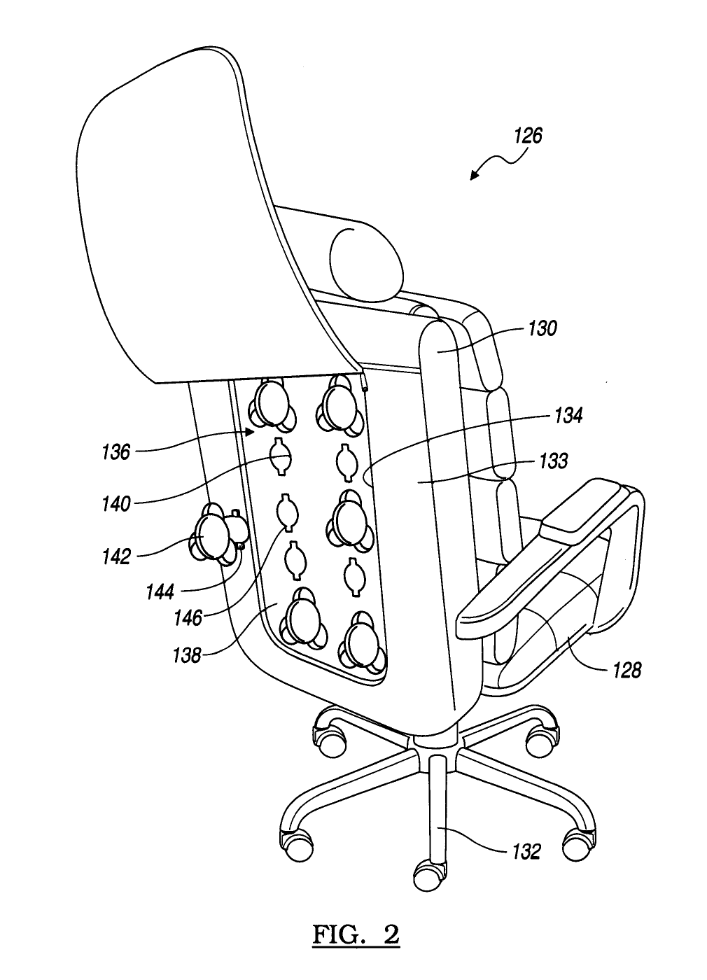

Referring now to FIG. 2, another massage apparatus is illustrated, which is depicted as a chair 126, which is similar to the chair 100 of the prior embodiment. The chair 126 includes a seat bottom 128 and a seat back 130 supported upon a base 132. The seat back 130 includes a frame 133 that defines a cavity 134 for retaining a massage assembly 136. The massage assembly 136 includes a substrate 138 that is mounted directly to the frame 133 of the seat back 130. The substrate 138 includes a series of receptacles 140, each configured to receive a vibratory massage unit 142. Each massage unit 142 has a motor-driven eccentric weight for imparting a vibratory massage effect.

Each of the massage units 142 includes a first locking component 144 for cooperating with a second locking component 146 of the associated receptacle 140 for locking the massage unit 142 to the substrate 138. The first locking component 144 can be a pair of radially extending tabs 144 that are received within a corresponding pair of radial slots 146 in the substrate 138. After the massage unit 142 is inserted into the associated receptacle 140, rotation of the massage unit 142 locks the massage unit 144 to the substrate 138.

The receptacles 140 may each be wired to the power and controls of the chair 126 for powering and controlling the associated massage unit 142 once installed.

The removable massage units 142 permit a user to remove a faulty massage unit 142 for repair or replacement. For example, the faulty massage unit 142 may be interchanged with an operable massage unit 142. The faulty massage unit 142 may be shipped to the manufacturer for repair or replacement. The series of receptacles 140 permit the user to select a desired massage operation capability by selecting which receptacles 140 receive the massage units 142. Additionally, the substrate 138 may be removable for interchangeability with other substrates 138 having varying receptacle 140 patterns for varying the pattern of massage permitted to the occupant. Additionally, other massage units 142 may be provided with varying massage effects, such as the massage operation, intensity, or the like, so that the user may select the desired massage effect for a particular receptacle 140.

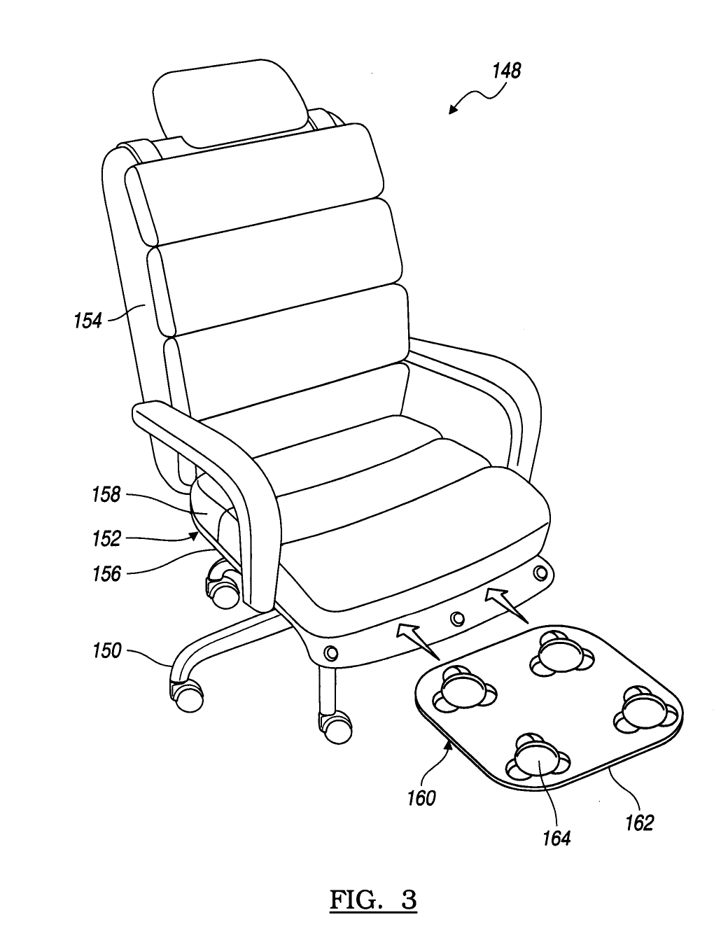

Referring now to FIG. 3, another massage apparatus is illustrated embodied as a chair 148. The chair 148 is similar to the prior embodiments and includes a base 150 for supporting a seat bottom 152 and a seat back 154.

The seat bottom 152 includes a frame 156 and cushioning and a cover 158. A massage assembly 160 is detachable from the frame 156 for imparting a massage effect beneath the cushioning and cover 158 that is consequently imparted to a user seated thereupon. The massage assembly 160 includes a substrate 162 that is configured to be detachably secured to the frame 156 by any known suitable mechanical attachment device, such as fasteners, clamps or the like. The substrate 162 includes a series of massage units 164 secured thereto, which each include a motor-driven eccentric weight for imparting a vibratory massage effect. The massage assembly 160 includes a wire harness for connection to a corresponding wire harness of the chair 148 for imparting power and controls to the massage assembly 160. The removable massage unit 160 permits the user to remove the massage unit 160 if desired. Additionally, the user may remove the massage assembly 160 for repair or replacement of any of the massage units 164. Alternatively, each of the massage units 164 may be detachable from the substrate 162 for alternating with varying massage units 164 or for adjustment of a pattern of the massage.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. Additionally, features of various implementing embodiments may be combined to form further embodiments of the invention.

What is claimed is:

1. A massager comprising:
a body support member having a frame with a cavity;
a substrate mounted to the frame, the substrate having a series of receptacles; and
a plurality of removable vibratory massage units, each mounted within one of the receptacles for imparting a vibratory massage effect to the body support member.

2. The massager of claim 1 wherein the substrate is detachable from the frame.

3. The massager of claim 1 wherein the plurality of massage units further comprises at least two massage units with varying massage effects.

4. The massager of claim 1 wherein the body support member further comprises a seat bottom.

5. The massager of claim 1 wherein the body support member further comprises a seat back.

6. The massager of claim 5 further comprising a cover flap for enclosing the substrate and the plurality of massage units within the cavity.

7. The massager of claim 1 wherein each of the series of receptacles further comprises a first locking component; and
wherein each of the plurality of massage units further comprises a second locking component for cooperating with the first locking component with one of the series of receptacles.

8. The massager of claim 7 wherein each first locking component further comprises one of a radial slot and a radially extending tab; and
wherein each second locking component further comprises the other of the radial slot and the radially extending tab.

9. A massage chair comprising:
a base for resting upon an underlying support surface;
a seat bottom supported upon the base;
a seat back supported by at least one of the base and the seat bottom; and
a massager according to claim 1, provided in at least one of the seat bottom and the seat back.

10. A massage chair comprising:
a base for resting upon an underlying support surface;
a seat bottom supported upon the base;
a seat back supported by at least one of the base and the seat bottom;
a first massager according to claim 1, provided in the seat bottom; and
a second massager according to claim 1, provided in the seat back.

11. A massage chair comprising:
a base for resting upon an underlying support surface;
a seat bottom supported upon the base, the seat bottom having a frame with a cavity;
a seat back supported by at least one of the base and the seat bottom; and
a removable massage assembly installed to the seat bottom frame.

12. The massage chair of claim 11 further comprising:
a substrate mounted to the seat bottom cavity, the substrate having a series of receptacles; and
a plurality of removable vibratory massage units, each mounted within one of the receptacles for imparting a vibratory massage effect to the seat bottom.

13. The massage chair of claim 12 wherein the substrate is detachable from the frame.

14. The massage chair of claim 12 wherein each of the series of receptacles further comprises a first locking component; and
wherein each of the plurality of massage units further comprises a second locking component.

15. The massage chair of claim 14 wherein each first locking component further comprises at least one radial slot.

16. The massage chair of claim 15 wherein each second locking component further comprises at least one radially extending tab.

17. A method for permitting selective removal of a massage assembly from a massager comprising:
providing a body support member with a frame and a cavity;
providing a substrate with a series of receptacles;
installing the substrate to the frame;
providing a plurality of removable vibratory massage units; and
installing the plurality of massage units in the receptacles.

18. The method of claim 17 further comprising:
providing a second substrate with a different pattern of receptacles than the first substrate;
removing the first substrate; and
installing the second substrate to the frame.

19. The method of claim 17 further comprising:
removing at least one of the plurality of massage units; and
if faulty, sending the at least one removed massage unit for repair or replacement.

20. The method of claim 17 further comprising arranging the plurality of massage units in a desired arrangement in the receptacles.
